(19) United States
(12) Patent Application Publication
(10) Pub. No.: US 2005/0117917 A1
(43) Pub. Date: Jun. 2, 2005

(54) Printing method and image forming apparatus having adjustable warm-up-time

(75) Inventors: Don-seon Lee, Yongin-si (KR); Jae-Kyoo Kang, Yongin-si (KR); Bong-Gi Lcl, Yeongiong-dong (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/000,280

(22) Filed: Dec. 1, 2004

(30) Foreign Application Priority Data
Dec. 2, 2003 (KR) 2003-86751
Dec. 29, 2003 (KR) 2003-99042

(51) Int. Cl. G03G 15/00

(52) U.S. Cl. 399/1

(57) ABSTRACT

Disclosed are a method for automatically adjusting the warm-up time of an image forming apparatus and an apparatus for performing the method. A printing method of an image forming apparatus comprises receiving geographical data and print time data, setting a warm-up time of the image forming apparatus on the basis of the received data, warming up the image forming apparatus for the set warm-up time when warm-up is necessary, and starting a print job of the image forming apparatus as needed. Accordingly, the warm-up time is automatically adjusted according to the geographical location of the image forming apparatus.

### CROSS-REFERENCE TO RELATED APPLICATIONS

This application claims the benefit under 35 U.S.C. §119(a) of Korean Patent Application Nos. 2003-86751, filed on Dec. 2, 2003 and 2003-99042, filed on Dec. 29, 2003, in the Korean Intellectual Property Office, the entire disclosure of each application being hereby incorporated by reference.

### BACKGROUND OF THE INVENTION

1. Field of the Invention

The present invention relates to image forming technology. More particularly, the present invention relates to a printing method and an image forming apparatus capable of automatically adjusting the warm-up time of an image forming apparatus suitable for its surrounding environment.

2. Description of the Related Art

An image forming apparatus is an apparatus that outputs images on a portable physical medium so users can see the image. Examples of image forming apparatuses include laser printers, copiers, facsimiles, and the like. Examples of the physical medium include various types of paper, transparencies and the like.

In the case of an image forming apparatus, such as a laser printer, under the control of an image-forming application having a graphic engine program, which operates through the computer's operating system, image data corresponding to control commands of a printer are created and transferred to the printer through a serial, parallel, or network interface. A video control unit of the printer analyzes the image data and creates bit map images to be printed. The bit map images are transferred to a developing unit of the printer under the control of the engine control unit of the printer, and are printed on a sheet of paper so the user can see the image.

If power is applied to the printer or the printer is released from a power save mode, the engine control unit turns on a lamp in the printer, and heats the printer to a temperature suitable for uniformly fixing a developer, that is, a toner, on a printed sheet in a developing unit. This is known as preheating or warm-up. In addition, the time taken to reach the suitable temperature from an internal temperature of the printer in the power save mode or before power is applied to the printer is referred to as the warm-up time.

Warming-up the printer before printing images is necessary to provide a proper environment for the toner to be fixed on a paper.

In a case of a conventional printer, the engine control unit has warm-up time data, and the developing unit performs a print job after performing the warm-up on the basis of the warm-up time data. The warm-up time is determined on the basis of an experimental value during the production of the image forming apparatus or a numerical value sensed by using a specific sensor such as a thermometer, and the printer performs the warm-up in accordance with the value.

However, when the warm-up is performed on the basis of such an experimental value or a sensed numerical value, there is a chance that a resultant sheet on which the toner is not properly fixed might be output, which is a problem. That is, in a case of carrying out a first print job after applying power to the printer, or in a case of carrying out a print job in the morning when the ambient temperature is low, the toner may not be properly fixed on a printed sheet. This occurs because the warm-up time prescribed for the image forming apparatus is not long enough and a print job is carried out at a temperature lower than a temperature suitable for fixing a toner.

Meanwhile, when the warm-up time of the image forming apparatus is specified in advance, the warm-up time cannot be controlled to be suitable for the surrounding environment of the image forming apparatus. Consequently, it is difficult to solve the above problem.

The problem of not being able to adjust the warm-up time is common to image forming apparatuses such as copiers, facsimile machines, and the like, employing an electrophotographic developing method, as well as laser printers.

### SUMMARY OF THE INVENTION

The present invention provides a printing method and an image forming apparatus having an adjustable warm-up time.

According to an aspect of the present invention, there is provided a printing method of an image forming apparatus having an adjustable warm-up time. The method comprises: (a) receiving geographical data and print time data; (b) setting the warm-up time of the image forming apparatus in accordance with a predetermined reference based on the received data; (c) warming up the image forming apparatus for the set warm-up time when warm-up is necessary; and (d) starting a print job as needed.

According to another aspect of the present invention, there is provided a printing method of an image forming apparatus having an adjustable warm-up time, the method comprising: (a) receiving and storing data on the warm-up time input by a user; (b) warming up the image forming apparatus to raise a temperature of the image forming apparatus in accordance with the stored data on the warm-up time and in accordance with data on a preset warm-up time when the data on the warm-up time is not stored; and (c) starting a print job after the warm-up time has expired.

According to another aspect of the present invention, there is provided an image forming apparatus having an adjustable warm-up time, the apparatus comprises a position data input unit that receives geographical data and print time data of the image forming apparatus; a warm-up time setting unit that sets the warm-up time in accordance with a predetermined reference based on the data received by the position data input unit; a memory unit that stores the warm-up time set by the warm-up time setting unit; and a print control unit that reads out the data on the warm-up time stored in the memory unit, and warms up the image forming apparatus for the read-out warm-up time.

According to another aspect of the present invention, there is provided an image forming apparatus having an adjustable warm-up time, the apparatus comprising a warm-up time input unit that receives data regarding the warm-up time input by a user; a memory unit that stores the data regarding the warm-up time received through the warm-up time input unit; and a print control unit that reads out the data regarding the warm-up time stored in the memory unit, and warms up the image forming apparatus for the read-out warm-up time.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating an exemplary embodiment of a printing method capable of adjusting warm-up time according to an embodiment of the present invention;

FIG. 2 is a block diagram illustrating the structure of an exemplary embodiment of a printing apparatus capable of adjusting warm-up time according to an embodiment of the present invention;

FIG. 3 is a flowchart illustrating another exemplary embodiment of the printing method capable of adjusting warm-up time according to an embodiment of the present invention;

FIG. 4 is a block diagram illustrating the structure of another exemplary embodiment of the printing apparatus capable of adjusting warm-up time according to an embodiment of the present invention;

FIG. 5 is a flowchart illustrating an example of application of the printing method capable of adjusting warm-up time according to an embodiment of the present invention shown in FIG. 3; and

FIG. 6 illustrates a computer screen for allowing a user to input the warm-up time to a printer through a menu provided by a printer driver program according to an embodiment of the present invention.

Throughout the drawings, that like reference numbers will be understood to refer to like elements, features and structures.

### DETAILED DESCRIPTION OF THE EXEMPLARY EMBODIMENTS

The present invention will now be described in detail with reference to the attached drawings, in which exemplary embodiments of the invention are shown.

FIG. 1 is a flowchart illustrating an exemplary printing method capable of adjusting warm-up time according to an embodiment of the present invention.

Referring to FIG. 1, in step 100, geographical data about the place where an image forming apparatus, such as a printer, is placed and print time data are input. Based on the received data, a warm-up time for the image forming apparatus is set (step 110). When warm-up is necessary, the warm-up is carried out for the warm-up time set in step 110 (step 120). After the warm-up time has expired, a print job may be started by the image forming apparatus as needed (step 130).

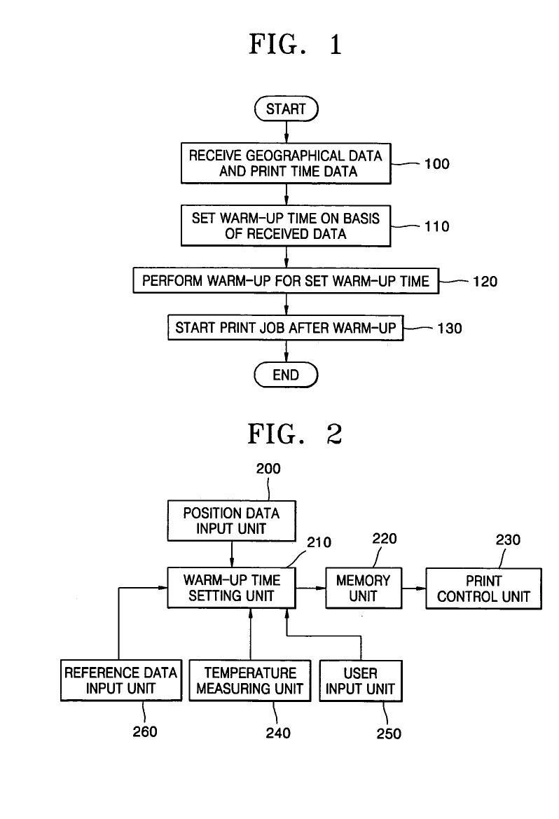

FIG. 2 is a block diagram illustrating the structure of an exemplary embodiment of a printer capable of adjusting the warm-up time according to an embodiment of the present invention.

Referring to FIG. 2, the printer comprises a position data input unit 200 that receives geographical data about the place where the printer is located and print time data, a warm-up time setting unit 210 that sets the warm-up time in accordance with a predetermined reference based on the data input through the position data input unit 200, a memory unit 220 that stores the warm-up time set by the warm-up time setting unit 210, and a print control unit 230, which reads out the warm-up time stored in the memory unit 220, performs the warm-up for the warm-up time, and thus raises the temperature of the image forming apparatus to allow the developer to be fixed.

The printer further comprises a temperature measuring unit 240 that can measure the internal and external temperatures of the printer, a user input unit 250 that receives data regarding the warm-up time input by a user, and a reference data input unit 260 to which a reference for setting the warm-up time is input.

Embodiments of the present invention can be used in an image forming apparatus such as a laser printer, a copier, a facsimile machine, or the like employing an electrophotographic developing method. The description below will mainly focus on a laser printer as the image forming apparatus. However, embodiments of the present invention apply to all image forming apparatuses employing an electrophotographic developing method.

In addition, in order to be concise, well-known details about the functions or structures of parts of an image forming apparatus, such as a printer, will not be described herein.

A printer is usually connected to a host computer that requests the printout of the documents. The position data input unit 200 may receive geographical data regarding the location of the printer and data including a print time from the computer connected to the printer.

For example, when installing an operating system in the computer, an area or a country in which the computer is located may be specified in order to set a language code. This may be changed after installing the operating system. The time for setting the warm-up time may be input from a real time clock (RTC) built into the computer.

That is, if the instructions to set the warm-up time are transferred to the printer through the computer, such data is input through the position data input unit 200 (step 100).

Alternatively, in the same manner as the computer, the location of the printer may be input to the printer according to an embodiment of the present invention, and time data may be input thereto as providing by the built-in RTC in the printer. As the geographical data regarding the location in which the printer is placed, a latitude and a longitude may be input to the printer.

In this case, the position data input unit 200 may be embodied as a keypad mounted on an external surface of the printer to allow the user to input data, a display unit such as an LCD window or the like, which can display an input menu and data input by the user, and a proper program for operating in the printer. The position data input unit 200 may also be used as the user input unit 250.

It will be apparent to those skilled in the art that the program operating in the printer may be embodied in firmware, software or hardware as a program, whose codes can be stored and executed in a memory such as a ROM built into the printer.

The geographical data and the time data are input to the warm-up time setting unit 210 and are used as the basic data for setting the warm-up time.

Step 110 of setting the warm-up time will now be described in more detail.

If a country or an area in which the printer is located is determined, the approximate latitude and longitude of the printer are also determined. Alternatively, the exact latitude and longitude may be directly input. Further, if the warm-up time is determined, a season and a time zone at the location of the printer may be known, and a temperature based on a statistical reference or an average temperature determined statistically may be estimated. Also, other factors, such as humidity of the area, may be statistically determined.

Since the warm-up time is used to adjust a temperature so that toner can be fixed on a printed sheet before performing a print job, the temperature of the area in which the printer is located is an important factor for determining the warm-up time. Thus, it is important to estimate the temperature.

The statistical reference serves as a predetermined reference for allowing the warm-up time setting unit 210 to set the warm-up time. The statistical reference may be adjusted through experiments.

Here, it is preferable that the printer comprises the temperature measuring unit 240 that can measure the internal and external temperatures of the printer so as to enlarge the basic statistical reference data on the internal and external temperatures of the printer. It is also preferable that the warm-up time setting unit 210 sets the warm-up time on the basis of the external temperature of the printer, which is estimated based on the data input through the position data input unit 200 and the actual temperatures inside and outside the printer that are measured by means of the temperature measuring unit 240.

That is, the warm-up time is determined in consideration of the measured temperature as well as the statistical reference.

When the weather where the printer is goes out of a predetermined range, which can be statistically estimated, it may be necessary to receive data on the weather, specifically, the temperature, from the user and/or from the temperature measuring unit 240 to set a warm-up time. For this purpose, it is preferable that the printer further comprises the user input unit 250 that receives data on the warm-up time from the user, and the warm-up time setting unit 210 determines the warm-up time in consideration of the weather, the temperature, etc., additionally input by the user through the user input unit 250.

The user input unit 250 may be embodied as the position data input unit 200, and it may combine functions with the assistance of a proper control program. Alternatively, the user input unit 250 may preferably be embodied as software in the computer connected to the printer.

In a case where the user inputs data such as the humidity, temperature, or the like, if the temperature around the printer is so low that the warm-up time of the printer is too short, the user may be allowed to input the warm-up time.

For this purpose, it is preferable that after step 100, the warm-up time is received from the user through the user input unit 250, the warm-up time setting unit 210 sets the warm-up time in step 110, and when the warm-up time input by the user after step 100 is longer than the warm-up time set by the warm-up time setting unit 210, the warm-up time input by the user is set as a new warm-up time. Using a user-input warm-up time that is longer than the preset warm-up time may improve print quality. When the warm-up time input by the user is shorter than the warm-up time set by the warm-up time setting unit 210, the warm-up time input by the user is not accepted because it may reduce print quality; the warm-up time input by the user is only accepted as a new warm-up time when it is longer than the warm-up time set by the warm-up time setting unit 210.

In the case where the user directly inputs the warm-up time will be described in more detail later with reference to another exemplary embodiment of the present invention.

Predetermined references according to which the warm-up time setting unit 210 sets the warm-up time include position data, time data, peripheral temperature data, and data input by the user, and the warm-up time is calculated as a function of the predetermined references. The predetermined references may be generated as a structure such as a table, the warm-up time may be preset on the basis of the position data and the time data, and a final warm-up time may be set by reflecting a control value based on other input data.

It is preferable that the predetermined references can be updated to improve their accuracy statistically or experimentally. Since it is difficult for the user to input the references for setting the warm-up time, it is preferable that a particular input unit that updates the references is further provided. For this purpose, it is preferable that the warm-up time setting unit 210 further comprises a reference data input unit 260 to which references for setting the warm-up time can be input.

The reference data input unit 260 may be embodied for receiving data on the references from the computer connected to the printer, or may be embodied to receive data transmitted directly to the printer over the Internet. In the latter case, the reference data input unit 260 should include a function for connecting to the Internet.

The reference data transferred to the printer through the reference data input unit 260 may be transferred to the warm-up time setting unit 210, or may be first stored in the memory unit 220 and then read out by the warm-up time setting unit 210 as needed.

The warm-up time set by the warm-up time setting unit 210 is stored in the memory unit 220, and when warm-up is necessary, the print control unit 230 reads out the warm-up time from the memory unit 220 and performs the warm-up based thereon (step 120).

When performing the warm-up, the print control unit 230 applies power to a heating unit such as a lamp to raise the temperature to a level at which the toner can be fixed in the printer and maintains that temperature.

In the case, where power is applied to the printer or, in the case, where a stand-by mode is entered when the internal temperature of the printer drops below a predetermined level, warm-up is probably necessary. The internal temperature may drop below the predetermined level when the printer does not operate for a predetermined time, and thus the power save mode or a sleep mode is maintained for a long time.

After performing the warm-up, a print job is started under the control of the print control unit 230, as needed (step 130). The printer does not always perform a print job after warm-up. When the printer is in the power save mode and receives a print request, the printer returns to a normal state and starts the print job. Since the printer does not always receive a print request right after it is turned on or right after it is released from the power save mode, step 130 is not always performed after the warm-up time is set and the warm-up is performed for the set warm-up time.

However, the internal temperature should be raised to a temperature suitable for fixing toner through the warm-up process to improve print quality. Therefore, when a predetermined reference for setting the warm-time is updated by an external input, it is preferable that the print job is performed after warming-up the printer for the warm-up time reset in accordance with the updated reference.

It is also possible within the scope of embodiments of the present invention for functions related to the printing method shown in FIG. 1 and the image forming apparatus shown in FIG. 2 to be distributed between a computer and a printer.

For example, the position data input unit 200, the warm-up time setting unit 210, the temperature measuring unit 240, the user input unit 250, and the reference data input unit 260 may be embodied in the form of a printer device driver in a computer, and the warm-up time set by the warm-up time setting unit 210 is transferred to the memory unit 220 built into the printer and read out by the print control unit 230 of the printer in order to perform the warm-up for the warm-up time.

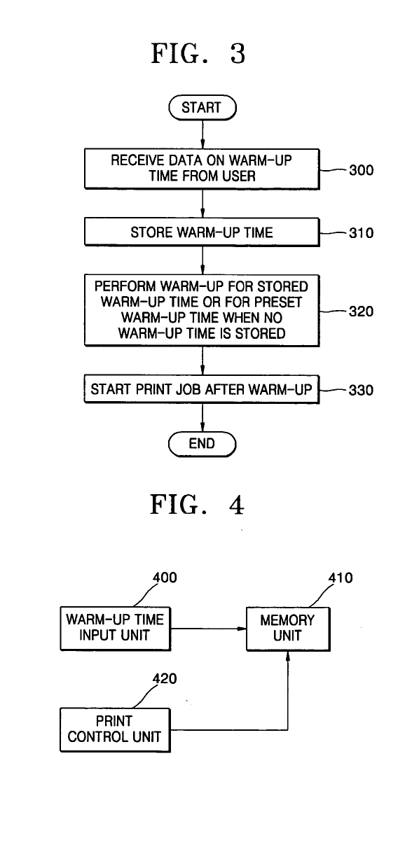

FIG. 3 is a flowchart illustrating another exemplary embodiment according to the present invention of the printing method capable of adjusting warm-up time.

In the printing method, which is executed in an image forming apparatus such as a printer, the warm-up time is input by a user (step 300) and stored (step 310), the image forming apparatus is warmed up in accordance with the stored warm-up time when the warm-up time is stored in step 310, and in accordance with data regarding a predetermined warm-up time when the warm-up time is not stored (step 320), and a print job is started as needed (step 330).

FIG. 4 is a block diagram illustrating the structure of another exemplary embodiment according to the present invention of the printing apparatus capable of adjusting the warm-up time.

The printing apparatus comprises a warm-up time input unit 400 that receives the warm-up time from the user, a memory unit 410 that stores the warm-up time received through the warm-up time input unit 400, a print control unit 420, which reads out the warm-up time stored in the memory unit 410, warms up the printing apparatus for the read-out warm-up time to the required temperature in order for the printing apparatus to fix images to be printed.

When the user wants to adjust the warm-up time of the printer, the user inputs a desired warm-up time through the warm-up time input unit 400 (step 300).

The warm-up time input unit 400, like the user input unit 250 of FIG. 2, may be embodied as a keypad mounted on an external surface of the printer to allow the user to input the warm-up time, a display unit, such as an LCD window or the like, which can display an input menu and the warm-up time input by the user, and a proper program for operating in the printer.

The user can input the warm-up time through the computer that is connected to the printer and transmits data to be printed.

The warm-up time input by the user is converted into digital values and stored in the memory unit 410 (step 310). Since the memory unit 410 should maintain the warm-up time once stored, even after the printer is turned off, and receives and stores other values again even after the warm-up time is stored, the memory unit may be embodied as a flash memory.

When warm-up is necessary, the print control unit 420 reads out the warm-up time stored in the memory unit 410 and performs the warm-up for the read-out warm-up time in order to raise the temperature to be suitable for fixing images to be printed (step 320). In order to raise the internal temperature of the printer up to a temperature at which the toner can be fixed, during the warm-up process, and to maintain the temperature, the print control unit 420 supplies power to a heating unit such as a lamp.

In the case where power is applied to the printer or, the case, where a stand-by mode is entered when the internal temperature of the printer drops below a predetermined level, the print control unit 420 performs the warm-up. Here, the internal temperature may drop below the predetermined level, when the printer does not operate for a predetermined time, and thus the power save mode or a sleep mode is entered. When the printer is restored to the stand-by state, it is preferable that the print control unit 420 reads out the warm-up time input by the user and stored in the memory unit 410 and performs the warm-up.

A predetermined warm-up time used when the user does not input the warm-up time is stored in the printer in advance (for example, in the course of producing the printer before step 300). Therefore, when the print control unit 420 confirms that the warm-up time is not input by the user, it is preferable that the print control unit 420 performs the warm-up for the stored predetermined warm-up time (step 320). This is because the printer can always perform a good-quality print job if it undergoes the warm-up.

After performing the warm-up, the printer starts the print job, as needed (step 130). The printer does not always need to perform the print job after performing the warm-up. When the printer is in the power save mode and receives a print request, it returns to a normal state and starts the print job. However, for example, since the printer does not always receive a print request right after the printer is turned on or when the printer is released from the power save mode, step 130 is not always performed right after warm-up.

When the printer is turned on, bit values which can be expressed by a memory element are all digital values such as all 0s or all 1s. Therefore, when the print control unit 420 reads out the values stored in the memory unit 410 and the overall bit values are 0 or 1, it means that the user did not input the warm-up time yet. In this case, the warm-up is performed in accordance with the preset warm-up time.

However, due to certain factors, the overall bit values stored in the memory unit 410 may not be all 0sor all 1s. In order to prevent the print control unit 420 from reading out the wrong warm-up time and operating, the memory unit 410 may be embodied such that a particular bit area is set and the set bit area has a particular value (for example, to be set from 0 to 1) only when data is input through the warm-up time input unit 400 by the user. The print control unit 420 confirms that the user has input the warm-up time data referring to the values of the set bit area, and reads out the values from the memory unit 410 for use as the warm-up time.

The predetermined warm-up time previously set in the course of manufacturing the printer reflects an experimental value in consideration of factors such as an average temperature, an average humidity, etc., at the printer's expected final location. Alternatively, the warm-up may be performed by preheating the printer to a predetermined temperature, which is confirmed using a temperature sensor built into the printer. Since more heat for maintaining the internal temperature for fixing the developer can be supplied if the warm-up time is increased, a longer warm-up time can improve print quality. However, when the warm-up time is too short, the print quality, specifically, the print quality of the first sheet after performing the warm-up, may not be good.

Therefore, it is preferable that the warm-up time input by the user not be too short. For this reason, when the warm-up time input by the user through the warm-up time input unit 400 is less than the stored predetermined warm-up time, it is preferable that the print control unit 420 neglects the warm-up time input by the user, and performs the warm-up on the basis of the stored predetermined warm-up time.

Preferably, in order to obtain sufficient warm-up efficiency, the print control unit 420 performs the warm-up before the developer (toner) is transferred to print the first sheet.

When the user inputs a new warm-up time while the printer performs a normal print job, another warm-up process is not necessary, because the printer is already preheated. Therefore, in the case, where after the printer is turned on and the warm-up is performed, and a new warm-up time is input by the user through the warm-up time input unit 400 and is stored in the memory unit 410, the next time a warm-up is required, the print control unit 420 performs the warm-up using the new warm-up time stored in the memory unit 410.

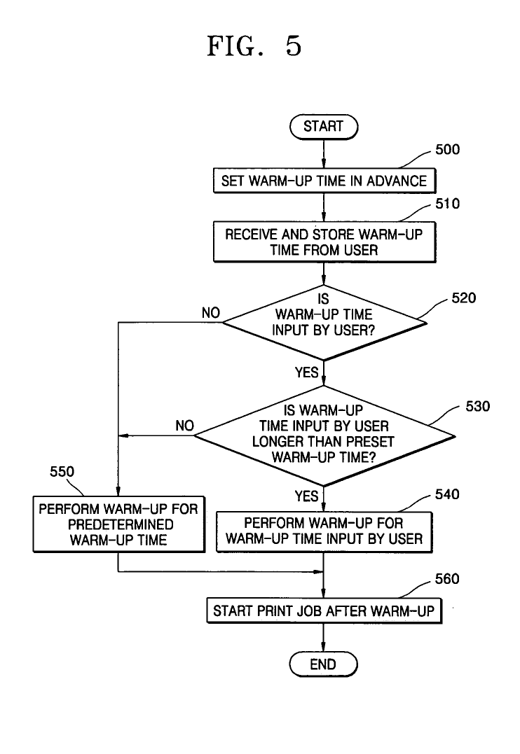

FIG. 5 is a flowchart illustrating an example of an application of the printing method of FIG. 3 capable of adjusting the warm-up time according to an embodiment of the present invention.

A warm-up time is set in the course of manufacturing the printer (step 500). If a warm-up time is input by the user, the input warm-up time is stored in the memory unit 410 (step 510).

It is described above that the user inputs the warm-up time through a means built into the printer. Alternatively, the user may input the warm-up time by using a computer that is connected to the printer. An operating system, such as Windows®, provides an exclusive printer driver that can transfer data to be printed to the printer and control the printer to obtain the desired printed results. Through this driver program, the user can input the warm-up time.

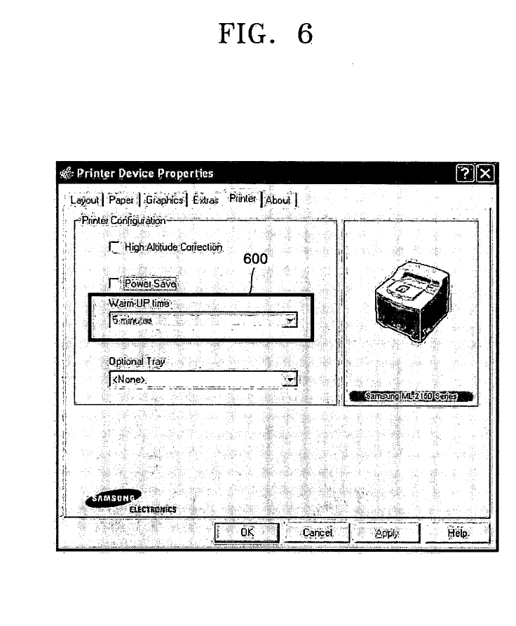

FIG. 6 illustrates an exemplary computer screen for allowing the user to input the warm-up time to the printer through a menu provided by the printer driver program according to an embodiment of the present invention. When the user inputs a desired value through the Warm-UP time menu indicated by reference numeral 600, the value is transferred to the printer through the operation of the printer driver program. In this case, the warm-up time input unit 400 reads out the warm-up time data input from the printer driver program through a printer-side interface that connects the printer to the computer, and stores the data on the warm-up time in the memory unit 410 (step 510).

Since the data transferred from the computer to the printer is based on a predetermined protocol, it is possible to easily read out the data on the warm-up time, as described above.

In order to perform the warm-up, the print control unit 420 confirms whether the warm-up time is input by the user (step 520). When it is confirmed that the warm-up time is input by the user, the print control unit 420 judges whether the warm-up time input by the user is longer than the predetermined warm-up time (step 530). When it is judged that the input warm-up time input by the user is longer than the predetermined warm-up time, the warm-up is performed using the warm-up time input by the user (step 540) to supply sufficient heat for printing. However, when the warm-up time is not input by the user (step 520), or when the warm-up time input by the user is shorter than the predetermined warm-up time (step 530), the warm-up is performed using the predetermined warm-up time (step 550). After completing the warm-up, the printer performs a print job as needed (step 560).

The procedure of the user inputting the warm-up time through the computer, which transfers the warm-up time to the printer is generally not applied to other image forming apparatuses, such as copiers and facsimile machines. This is because copiers and facsimile machines are not typically controlled through a separate computer. However, since embodiments of the present invention can be applied to a complex machine having functions of a printer and a copier, a printer and a facsimile, etc., the above description can be applied to apparatuses such as copiers and facsimile machines.

In the printing method of an image forming apparatus according to an embodiment of the present invention, by supplying the image forming apparatus with geographical data and print time data, setting a warm-up time on the basis of the data, performing the warm-up for the set warm-up time when necessary, and starting a print job after the warm-up, the warm-up time is automatically adjusted to suit the climate in which the image forming apparatus is located. As a result, it is possible to enhance the fixing efficiency of toner onto a print sheet, and thus it is possible to obtain printed sheets on which the toner has been suitably fixed in accordance with the suitable warm-up time.

While the present invention has been particularly shown and described with reference to exemplary embodiments thereof, it will be understood by those skilled in the art that various changes in form and details may be made therein without departing from the spirit and scope of the invention as defined by the appended claims and their equivalents.

In addition, it will be apparent to those skilled in the art that each step of the printing method according to embodiments of the present invention may be embodied in various ways, including software, hardware, of combination thereof.

1. A printing method for an image forming apparatus having an adjustable warm-up time, the method comprising the steps of:
(a) receiving geographical data and print time data;
(b) setting the warm-up time for warming up the image forming apparatus in accordance with a predetermined reference based on the received data;
(c) warming up the image forming apparatus for the set warm-up time, when the warm-up is necessary; and
(d) starting a print job as needed.

2. The printing method according to claim 1, wherein in step (b), the warm-up time is determined based on a temperature estimated on the basis of the data received in step (a), the regional location of the image forming apparatus, and an internal temperature of the image forming apparatus.

3. The printing method according to claim 1, wherein in step (b), the warm-up time is determined based on the temperature estimated on the basis of the data received in step (a), the regional location of the image forming apparatus, and an actually measured internal and external temperatures of the image forming apparatus.

4. The printing method according to claim 1, wherein the data received in step (a) includes warm-up time data input by a user, and in step (b), the warm-up time is determined in consideration of the data input by the user.

5. The printing method according to claim 1, wherein the predetermined reference for setting the warm-up time in step (b) is updated through inputs from outside of the image forming apparatus.

6. The printing method according to claim 1, wherein when the predetermined reference in step (b) is updated through the input from outside of the image forming apparatus, the print job is performed as needed after warming up the image forming apparatus for the warm-up time that is reset in accordance with the updated reference.

7. The printing method according to claim 1, further comprising the step of receiving and storing a warm-up time from the user after step (a),
wherein when the warm-up time received from the user is longer than the warm-up time set in step (b), the warm-up time is updated by replacing the warm-up time set in step (b) with the warm-up time received from the user.

8. A printing method of an image forming apparatus having an adjustable warm-up time, the method comprising the steps of:
(a) receiving and storing the warm-up time input by a user;
(b) warming up the image forming apparatus to raise a temperature of the image forming apparatus in accordance with the stored warm-up time when the warm-up time is stored, and in accordance with a predetermined warm-up time when the warm-up time is not stored; and
(c) starting a print job as needed.

9. The printing method according to claim 8, wherein in step (b), the image forming apparatus is warmed up in accordance with the predetermined warm-up time when the warm-up time input by the user in step (b) is shorter than the predetermined warm-up time.

10. An image forming apparatus having an adjustable warm-up time, the apparatus comprising:
a position data input unit that receives geographical data and print time data of the image forming apparatus;
a warm-up time setting unit that sets the warm-up time in accordance with a predetermined reference based on the data received by the position data input unit;
a memory unit that stores the warm-up time set by the warm-up time setting unit; and
a print control unit that reads out the data on the warm-up time stored in the memory unit and warms up the image forming apparatus for the read-out warm-up time.

11. The image forming apparatus according to claim 10, further comprising a temperature measuring unit that measures an internal temperature and an external temperature of the image forming apparatus,
wherein the warm-up time setting unit sets the warm-up time in accordance with a temperature estimated on the basis of the data input through the position data input unit and the internal and external temperatures of the image forming apparatus actually measured by the temperature measuring unit.

12. The image forming apparatus according to claim 11, further comprising a user input unit that receives data such as weather data and temperature data input by a user for setting the warm-up time,
wherein the warm-up time setting unit sets the warm-up time in consideration of the data input by the user through the user input unit.

13. The image forming apparatus according to claim 12, wherein the warm-up time is input through the user input unit by the user, and when the warm-up time input by the user is longer than the warm-up time set by the warm-up time setting unit, the warm time is updated by replacing the set warm-up time with the warm-up time input by the user.

14. The image forming apparatus according to claim 11, further comprising a reference data input unit that receives a reference in which the warm-up time setting unit sets the warm-up time.

15. An image forming apparatus having an adjustable warm-up time, the apparatus comprising:
a warm-up time input unit that receives the warm-up time input by a user;
a memory unit that stores the warm-up time input through the warm-up time input unit; and
a print control unit that reads out the warm-up time stored in the memory unit, and warms up the image forming apparatus for the read-out warm-up time.

16. The image forming apparatus according to claim 15, wherein when no warm-up time is input by the user, the print control unit warms up the image forming apparatus for a preset warm-up time.

17. The image forming apparatus according to claim 16, wherein the print control unit warms up the image forming apparatus for the preset warm-up time when a warm-up time input by the user through the warm-up time input unit is shorter than the preset warm-up time.

18. The image forming apparatus according to claim 15, wherein after power is applied to the image forming apparatus or when the image forming apparatus is released from a power save mode, the print control unit reads out the warm-up time input by the user that is stored in the memory unit and performs the warm-up.

19. The image forming apparatus according to claim 18, wherein the print control unit performs the warm-up right before transferring a developer for printing a first sheet.

20. The image forming apparatus according to claim 19, wherein when a new warm-up time is input by the user through the warm-up time input unit after power is applied to the image forming apparatus and the warm-up is performed, the print control unit performs the warm-up on the basis of the new warm-up time stored in the memory unit the next time the warm-up is required.
